(19) United States
(12) Patent Application Publication
(10) Pub. No.: US 2023/0090850 A1
(43) Pub. Date: Mar. 23, 2023

(54) WIRELESS ASPHALT MEASURING SYSTEM

(71) Applicant: Wally Jarnagin, Temple, TX (US)

(72) Inventor: Wally Jarnagin, Temple, TX (US)

(21) Appl. No.: 17/947,116

(22) Filed: Sep. 17, 2022

Related U.S. Application Data
(60) Provisional application No. 63/245,837, filed on Sep. 18, 2021.

(51) Int. Cl. E01C 23/01; G01J 5/10; G01B 11/06

(52) U.S. Cl. CPC E01C 23/01; G01J 5/10; G01B 11/06; G01J 2005/0077

(57) ABSTRACT

A wireless asphalt measuring system is disclosed herein. The system takes thermal data of the asphalt via a thermal camera and distance data from a distance measuring instrument. A processing unit then calculates a metric, such as yield, based on the thermal data and distance data. The distance measuring instrument may communicate wirelessly to the processing unit and the processing unit may communicate to a local device or via the internet, eliminating the possibility of wires being damaged and rendering the system inoperable.

### CROSS-REFERENCE TO RELATED APPLICATION

This application claims priority to U.S. Provisional Application No. 63/245,837, which was filed on Sep. 18, 2021, which is incorporated by reference herein in its entirety.

### FIELD OF THE INVENTION

This disclosure relates generally to asphalt paving. More specifically, it relates to a device for calculating metrics related to asphalt paving.

### BACKGROUND

Asphalt is used for roads, driveways, and parking lots all over the world. Paving machines are often used to lay down asphalt in long strips which have a uniform top surface which provides for a smooth ride for a motor vehicle traveling on the asphalt road.

Multiple paving companies often compete for customers by bidding jobs in advance based on the customer's plans. It is therefore imperative that the winning bidder tightly control costs to maintain profitability of the job. One of the largest drivers for this cost is the asphalt material itself.

In order to maintain durability of the asphalt surface, parameters such as thickness of the asphalt layer may be specified by an engineer or building code. If the asphalt layer is too thin, the durability of the asphalt may be compromised, causing damage that must be repaired at significant expense. Such a scenario may result in a lawsuit against the paving company by the customer for not adhering to the requirements. Conversely, if the asphalt layer is too thick, the excess material cost will erode the paving company's profit, potentially causing a loss.

In order to accurately gauge the thickness, or yield, of an asphalt layer, systems have been designed to calculate the yield. Such a system calculates the thickness using the horizontal area of pavement that is laid, the total weight of asphalt used, and the density of the asphalt material.

One such system is the MatManager System by TF Technologies. The MatManager system uses various components connected by wires to a processing unit with display. However, due to the hot, harsh environment of paving, these sensors or their wires are often damaged or obscured, rendering the device incapable of accurately measuring until the problem is corrected.

It would therefore be advantageous to have a device which avoids these and other drawbacks of existing methods and devices.

### SUMMARY OF THE INVENTION

An asphalt measuring system is provided that can be mounted on a paver and can calculate and send data and statistics about a paving job to one or more users. The system according to one embodiment comprises a thermal imaging camera, a distance measuring unit, and a processing unit connected to the thermal camera and distance measuring unit. The asphalt measuring system receives thermal data from the thermal camera, distance data from the distance measuring instrument, and calculates a metric based on the thermal data and distance data.

An asphalt measuring system according to embodiments may further comprise a DMI receiver connected to the processing unit for wirelessly receiving distance data from the distance measuring instrument.

Additionally, a GPS unit may be connected to the processing unit for providing location data. The measuring system may further comprise a wireless communication device for sending thermal data, distance data, or the calculated metric via the internet.

The metric calculated may be an area of the pavement and the system may also calculate a yield based on the calculated area of the pavement.

A method of measuring asphalt is also provided herein. The method comprises receiving, from a thermal camera, thermal data from a portion of pavement; receiving, from a distance measuring instrument, distance data; and calculating, by processing unit, a metric based on the thermal data and distance data.

The method may further comprise receiving distance data wirelessly by a DMI receiver. The method may still further include receiving, from a GPS unit, location data. A wireless communication device maybe used to send thermal data, distance data, or the calculated metric. The wireless communication device may be capable of communicating via internet connection. The calculated metric may be an area of pavement and the method may further comprise calculating a yield based on the calculated area of pavement.

### BRIEF DESCRIPTION OF THE DRAWINGS

FIG. 1 depicts an overall view of an asphalt mapping device mounted to a paving vehicle according to one embodiment.

FIG. 2 depicts a component-level view of an asphalt mapping device according to one embodiment.

### DETAILED DESCRIPTION

To ensure the quality of asphalt to a customer and control the cost to the paving contractor, it is important to track certain parameters of the asphalt, especially thickness (yield). Existing measurement systems suffer from several problems, such as being easily damaged and unreliable. To solve these and other problems of existing systems, an asphalt measuring system is provided.

For purposes of this disclosure, “asphalt” refers to any material that is fed into a paving machine and “pavement” refers to the material that has been laid down by the paving machine.

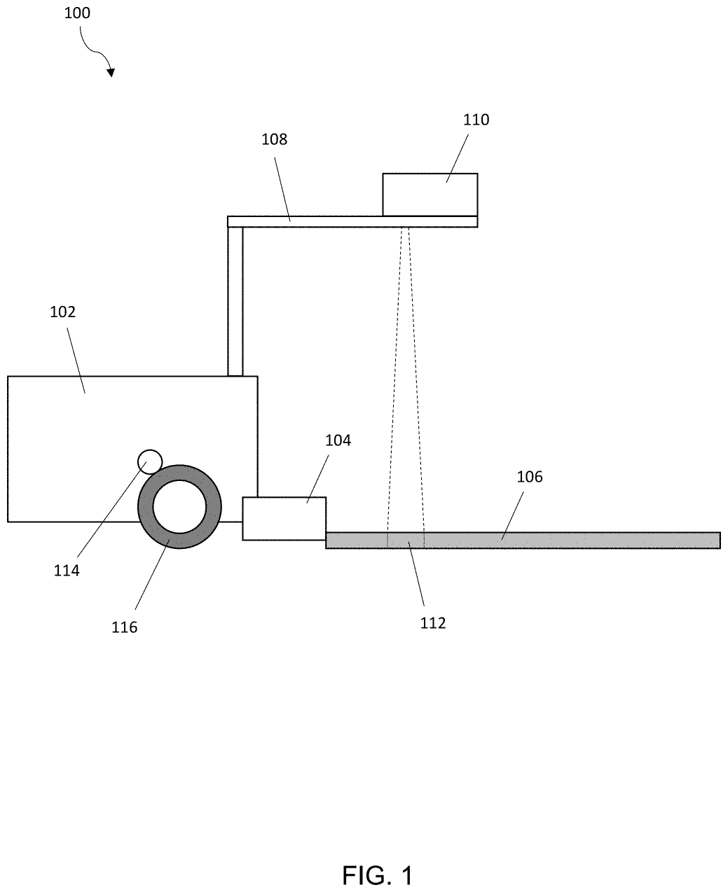

FIG. 1 depicts a side view of an asphalt paving machine with a wireless asphalt measuring system 100 mounted thereon according to one embodiment of the present invention. The system is used in conjunction with a paving machine (paver) 102 commonly used to lay asphalt. Asphalt is fed into the paver 102 by a dump truck in front of the paver. A screed 104 on the paver 102 flattens the asphalt as the paver 102 is moved along the ground, creating a pavement 106 behind the paver.

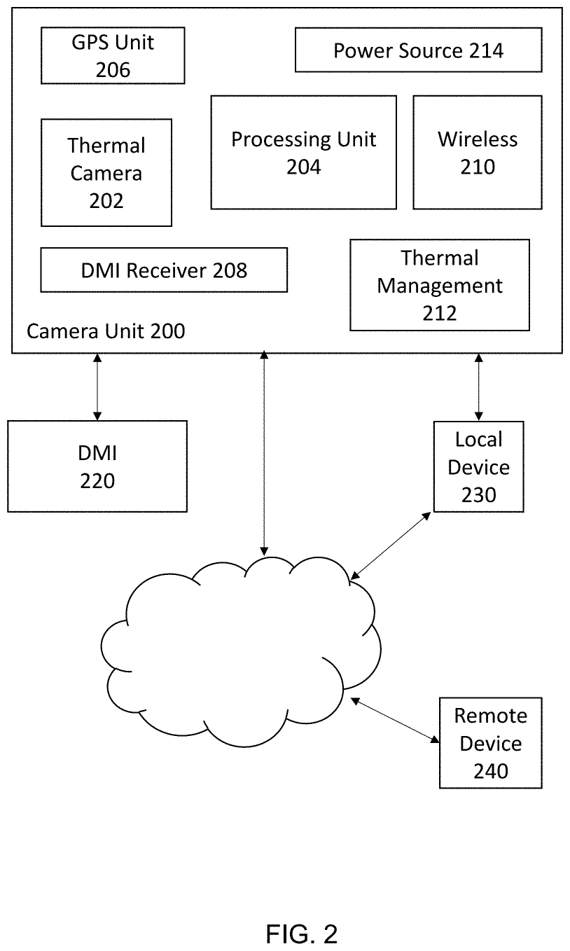

A boom 108 is mounted to the paver 102 and extends rearward past the screed 104. A camera unit 110 is mounted to the boom 108 such that it is above the pavement 106. The camera unit 110 houses several components of the system, as will be explained later with reference to FIG. 2. A thermal camera in the camera unit 110 points toward the ground and is able to view a sample 112 of the pavement 106. Sample 112 may be a one- or two-dimensional section of pavement 106 that encompasses the entire width of the pavement being laid down. Ideally, the thermal camera will be configured to view the entire width of the pavement as well as an additional distance past the width of the pavement on each side.

A Distance Measuring Instrument (DMI) 114 is connected to a wheel 116 or tracks of the paver 102, depending on the paver configuration. The DMI 114 may comprise a wheel driven by friction and connected to an encoder, such as an optical rotary encoder to measure the forward and backward movement of the paver 102. The DMI 114 communicates by wireless connection to camera unit 110, though a wired connection is possible.

Asphalt measuring system 100 uses the information gathered from the thermal camera and the DMI, along with other components, to provide a wide variety of statistics and other information about the pavement and the paving job to one or more users as will be explained later.

FIG. 2 shows a schematic of the various components of asphalt measuring system 100. Camera unit 200 comprises a rugged waterproof housing containing components 202-214 therein.

Thermal camera 202 may be any device capable of measuring the temperature of an object. For example, thermal camera 202 may be an infrared camera. Thermal camera 202 may be mounted externally to camera unit 200 or may be mounted internally, allowing the camera to view the pavement through an opening or window in camera unit 200. Thermal camera 202 is configured to view at least the entire width of the pavement being laid down. The thermal camera receives thermal data from its field of view and send the data to the processing unit 204 for processing. The thermal data may comprise temperatures for a plurality of points along the width of the pavement.

Processing unit 204 may be any type of computing device and may comprise a microchip processor and non-volatile memory. The processing unit 204 may interface to control, send, or receive data from the other components of the system. The processing unit may also perform calculations for the system, such as metrics, which will be described in greater detail below.

A GPS unit 206 receives location data which is then sent to the processing unit 204. The GPS unit may use real-time kinematic positioning (RTK) to obtain very accurate location data.

The DMI receiver 208 receives DMI data wirelessly from the DMI 220 and sends the DMI data to the processing unit 204. The DMI data comprises forward and reverse movements of the paver.

Using the thermal data, the location data, and the DMI data, the system can accurately calculate the size of the area paved and create 2D or 3D maps of the paved area.

At least one wireless communication device 210 is connected to the processing unit and is capable of sending and receiving data. Data may be sent via one or more method such as Bluetooth, WIFI, cellular signal, etc.

A local device 230, such as tablet or smartphone may be used by an operator to control the asphalt measuring system. The local device 230 may communicate directly to the camera unit 200 or may communicate via internet connection to camera unit 200 which is also connected to the internet. The local device 230 is so named because it is close to the camera unit 200. Real-time data and metrics may be sent from the camera unit 200 to the local device 230 as well as sent to a server or cloud. This data may be accessed via a remote device 240 which may be, for example, a customer, manager, or quality control person not in close proximity with the system.

The processing unit 204 may perform some, all, or none of the calculations, with any combination of servers or other devices performing the some, none, or all of the calculations for the maps or metrics. For example, processing unit 204 may calculate a paved area and send the paved area and GPS location data to a server which creates a map of the paved area.

Due to the heat produced by the electronic components and the hot asphalt below the camera unit, camera unit 200 may comprise one or more thermal management devices 212, such as heat sinks, fans, thermoelectric devices, etc.

The components of camera unit 200 may be powered be a power source 214 such as a rechargeable battery or solar panel. DMI 220 may be powered separately by a power source connected to or within the DMI.

Using data gathered from the various sensors, the system can calculate, store, and share various metrics for the paving job. The raw data and metrics may be stored on one or more devices of the system, including the camera unit, the local device, the cloud, a server, or a remote device. A user may connect to the system using a web browser or app to access the raw data and metrics.

The system may calculate metrics such as the minimum, maximum, average, median, etc. for the speed of the paver, the temperature for a specified section of pavement (i.e. every 100 ft. section), truck efficiency, truck trip time, current width of the pavement, the average width, time on the job, the time spent moving, the time spent waiting, the percentage of time spent moving, and the thickness (yield) of the pavement. The system may also create maps of the job, showing the area to be paved, the area already paved, the temperature of a paved area, weather conditions and timestamps at the time of paving. The metrics and maps may be visible as the job progresses and may also be stored for a specified time (i.e. 5 years) after the job has been completed to comply with company policies or legal requirements.

A connected device, such as a local device, may be used to set up, control, and monitor the system, data, or metrics. For example, an app on a smartphone may be connected to the camera unit via wireless connection. A user may input details for the job such as job name, location, operator, etc. The user may also set up or adjust a threshold temperature for detecting the pavement. In operation, the user may be able to start, pause, or stop tracking of a job.

In some instances, the system may have difficulty tracking a section of pavement. To accommodate this, a user may manually input parameters into the system such as square yardage. A built-in calculator may be used to assist the user in calculating the square yardage, for example for a cul-de-sac or knuckle.

Additionally, the system may track the trucks used to deliver the asphalt to the paver. The systems may automatically track the trucks using an e-ticketing system or a user may manually enter information about the trucks. The system may receive information about the trucks, such as a truck identification, truck time of loading, time spent waiting, time at start of dispensing, time at finish of dispensing, tonnage loaded, and tonnage dispensed. A contractor can input data at the plant when a truck is loaded and the system will time stamp when the asphalt was loaded then time stamp when the asphalt is unloaded at the job site. It can also GPS stamp each load. The tickets can be stored for later retrieval. The tickets may be manually or automatically emailed to one or more persons wishing to receive them. Automatic emails may be periodically sent, for example, at the end of the day for review by a supervisor.

In order to calculate the yield for the paving job, the system calculates the total square yardage of the job or a section of the job. The square yardage is calculated based on the thermal camera, DMI, and GPS as follows. As the paver moves, the DMI and GPS track the forward movement of the paver. Meanwhile, the thermal camera captures multiple images of a width of the pavement to create a thermal data. The system calculates a plurality of widths of the pavement based on the thermal data for a plurality of points along the path. For example, the system uses a temperature threshold set by the user to differentiate between freshly laid pavement and pavement from previous passes or non-paved areas. The system then calculates the square yardage based on the widths and length of the paved area. The yield can then be calculated based on the tonnage of asphalt used and the density of the asphalt.

It is contemplated that such a pavement tracking system could take many forms without departing from the spirit of the invention. For example, the DMI may contact the ground directly instead of contacting a wheel of the paver. The DMI may also use cameras, lasers, light, radar, lidar, or any other means to accurately measure the distance traveled by the paver. In other embodiments, the DMI may not be needed at all and the metrics may be calculated based on the thermal camera alone or with the GPS unit only.

The discussion herein of the present invention is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Herein, the terms “including,” “consisting of”, and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the description and claims to refer to particular system components and method steps. As one skilled in the art will appreciate, different companies may refer to a component by different names. This document does not intend to distinguish between components that differ in name but not function.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An asphalt measuring system, comprising:
a thermal camera;
a distance measuring instrument; and
a processing unit connected to the thermal camera and the distance measuring unit,
wherein the processing unit is designed to receive thermal data from the thermal camera, distance data from the distance measuring instrument, and calculate a metric based on the thermal data and distance data.

2. The asphalt measuring system of claim 1, further comprising:
a DMI receiver connected to the processing unit for wirelessly receiving distance data from the distance measuring instrument.

3. The asphalt measuring system of claim 1, further comprising:
a GPS unit connected to the processing unit for providing location data.

4. The asphalt measuring system of claim 1, further comprising:
a wireless communication device for sending thermal data, distance data, or the calculated metric.

5. The asphalt measuring system of claim 4, wherein the wireless communication device is capable of communicating via internet connection.

6. The asphalt measuring system of claim 1, wherein the metric is an area of pavement.

7. The asphalt measuring system of claim 6, wherein the processing unit is designed to calculate a yield based on the calculated area of pavement.

8. A method of measuring asphalt, comprising:
receiving, from a thermal camera, thermal data from a portion of pavement;
receiving, from a distance measuring instrument, distance data; and
calculating, by a processing unit, a metric based on the thermal data and the distance data.

9. The method of claim 8, wherein the distance data is received wirelessly by a DMI receiver.

10. The method of claim 8, further comprising:
receiving, from a GPS unit, location data.

11. The method of claim 8, further comprising:
sending, by a wireless communication device, thermal data, distance data, or the calculated metric.

12. The method of claim 11, wherein the wireless communication device is capable of communicating via internet connection.

13. The method of claim 8, wherein the metric is an area of pavement.

14. The method of claim 30, further comprising:
calculating a yield based on the calculated area of pavement.
